(19) United States
(12) Patent Application Publication
(10) Pub. No.: US 2017/0185950 A1
(43) Pub. Date: Jun. 29, 2017

(54) SYSTEM FOR MONITORING CARTS AND METHOD

(71) Applicant: DRACO LTD., Herzliya (IL)

(72) Inventor: Assaf Roet, Ramat Hasharon (IL)

(73) Assignee: DRACO LTD., Herzliya (IL)

(21) Appl. No.: 14/981,476

(22) Filed: Dec. 28, 2015

(51) Int. Cl. G06Q 10/08; B62B 5/00; B62B 3/14; G01S 19/13

(52) U.S. Cl. CPC G06Q 10/087; G01S 19/13; B62B 5/0096; B62B 3/1404

(57) ABSTRACT

A method for mitigating the loss of a cart, and a system which monitors each cart out of an inventory list of a plurality of carts. A cart may support a cart apparatus module, a cart data module, and a GPS tracker module. The system further includes a control station module and a data collection module. The cart apparatus module powers and charges an electronic device which is coupled thereto. The cart data module holds cart data pertaining to the cart, such as a cart identity number. The data collection module includes a plurality of data exchangers to derive cart data when a cart enters in communication range therewith. The control station module is coupled in communication with each data exchanger, and is configured to collect cart data via each data exchanger, store data exchanger location, and for each cart, to process and correlate time data, cart data, and stored data to derive a cart status condition, detect selected cart status conditions and recognize them as cart related event(s), and deliver a report notice in response to such event(s).

### TECHNICAL FIELD

Embodiments of the invention relate to the monitoring of carts, and in particular to prevention or mitigation of loss of carts which support equipment for powering cart supported electronic devices.

### BACKGROUND

Facilities such as retail stores typically house a large variety of offerings and traditionally occupy a large amount of floor space, making the time spent shopping relatively long Improving the shopping experience and time efficiency of customers in retail stores is thus an increasing aim. This same need exists also in other types of facilities such as airports, or the like.

Nowadays mobile electronic devices accompany us to most places we go. For example during shopping, mobile devices may be used to assist in guidance through the store or facility, in managing e.g. shopping lists and/or simply for communication. Thus providing means for placing electronic devices on carts may assist in improving the customer experience of a cart user.

Furthermore, such carts may be lost or taken away. Providing means for tracking a location of a lost cart may assist and mitigate potential losses, which is important in particular when such carts are equipped valuable accessories such as holding device for a shopping cart to receive a mobile device

US Patent Application No. 2013313297 to Winston Products LLC, recites a holding device for attachment to a shopping cart, for a mobile device to be received in the holding device. Furthermore, GB Patent Application No. 201118770 to Peter Corlett et al., divulges a cart stacked and interconnected to a power supply for charging an electronic device.

### SUMMARY

The following embodiments and aspects of the present claimed invention are described and illustrated in conjunction with systems, tools and methods which are meant to be exemplary and illustrative, not limiting in scope.

In a broad aspect of the embodiments of the presently claimed invention, there is provided a method and a system for monitoring carts, and in particular monitoring carts for the prevention or mitigation of loss of carts out of an inventory list of carts.

It is an object of the embodiments to prevent the loss of carts which support valuable equipment for powering cart-supported electronic devices.

There is provided a method and a cart monitoring system which may comprise a cart data module that is supported by the cart, and is configured to hold data pertaining to the specific cart. The cart data includes at least a cart identity number. The monitoring system may further comprise a data collection module which includes a plurality of data exchangers. The data exchangers are distributed a priori at predetermined known locations and are configured to derive cart data when a cart arrives in communication range therewith. The cart monitoring system may also store cart status conditions which pertain to each cart. In addition, the monitoring system may correlate and derive cart status conditions for each cart and detect selected cart status conditions as event(s) in response to which related to the cart and to deliver a report notice in response to such detected event(s).

The monitoring system may comprise carts which support a cart supported apparatus module which is operable to power and charge one or more electronic device(s) such as cellular phones and/or smart phones that are coupled thereto.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a side of view of stacked carts each including a cart apparatus module;

FIG. 2 schematically depicts a front view of a cart apparatus module;

FIG. 3 schematically illustrates a block diagram of an embodiment of a system and a method for monitoring carts;

FIG. 4 schematically shows an exemplary environment wherein a system and method for monitoring carts is operative; and

FIGS. 5 to 7 schematically depict block diagrams of various embodiments of a system and a method for monitoring carts.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

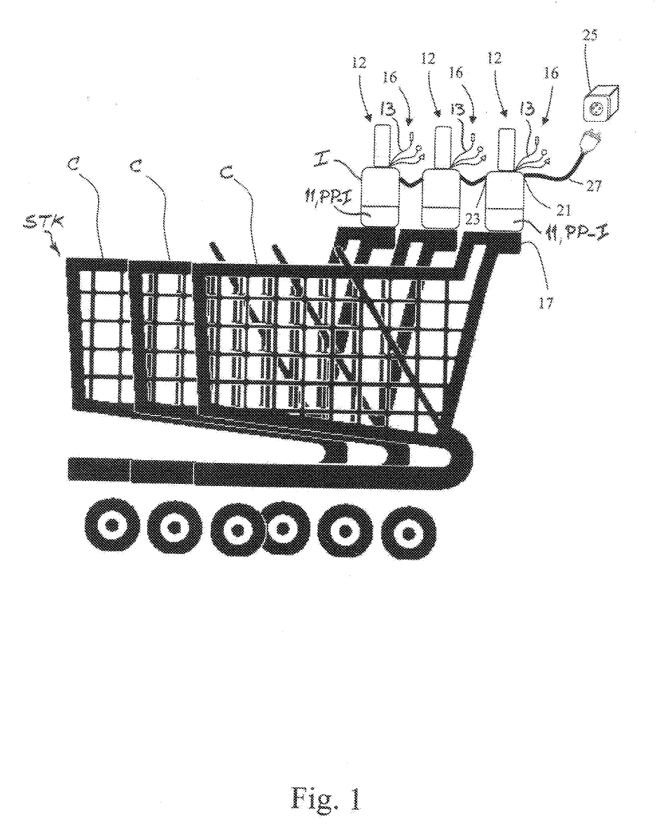

The word ‘cart’ as used herewith refers to a wheeled vehicle driven by a person, as shown for example in FIG. 1. The word ‘cart’ is interchangeable with for example, the following: shopping cart, retail store carriage, airport trolley and the like.

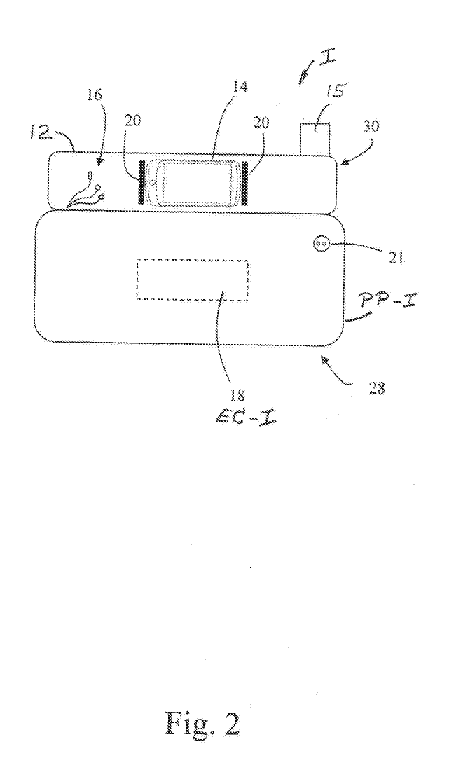

FIG. 1 illustrates a side-view of a stack STK of carts C, here three such carts, each one carrying cart apparatus module I, which may include a power pack PP-1 and a device support 12. The power pack PP-1 may include a rechargeable apparatus battery 11 and a bundle of apparatus cables 13 terminated by apparatus connectors 16 which may be coupled intermediate the apparatus battery 11 and an at least one electronic device 14 which is shown in FIG. 2. The electronic device 14 and an electronic circuit interface 18 or EC-I, are shown in FIG. 2. The apparatus connectors 16, here three such connectors, are configured each one to connect to a different type or a different design of charging port of an electronic device 14 which may be a portable or a mobile electronic device, or a cart-fixed electronic device requiring electrical power for operation. The wording ‘electronic device’ may include cell phones, displays screens, tablets, laptops, and the like. A user of a cart C, not shown, may thus take advantage of the cart apparatus module I to power one of his own personal electronic apparatus 14 such as a cellular phone or a tablet for example. The cart apparatus module I may also power additional electronic device 15 shown in FIG. 2, such as cart mounted displays for example, which may be fixedly supported by the holding device 30 shown in FIG. 2.

The cart apparatus module I, may be attached on or adjacent a handle 17 of the cart C, or may be mounted differently, and may be fixed to another portion of the cart.

The power pack PP-I may include an inlet interface 21, possibly configured as first front electrical interface 21 of the power pack PP-I, and an outlet interface 23, possibly configured as a second back electrical interface 23 of the power pack. In the exemplary embodiment of FIG. 1, the first power pack PP-I which is disposed on or close to the handle 17, at the right in FIG. 1, is shown to be electrically coupled by an electrical cable 27 connecting the first interface 21 to a stack charger 25 that in turn is coupled to a power source such as the mains. The stack charger 25 may be attached to a fixed structure, such as a wall of a building, or may be portable, and may be connected to an energized electrical circuit, such as the electric mains.

The power pack PP-1 of the rightmost cart C in FIG. 1 may be electrically coupled by another electrical cable, to connect the second outlet interface 23 to a first inlet interface 21 of a subsequent power pack PP-1 which is disposed in FIG. 1 to the left of the rightmost cart, which in turn may be connected by yet another electrical cable to a first interface 21 of a next adjacent power pack in line, here the last power pack, leftmost in FIG. 1. One or more power pack(s) PP-1, belonging e.g. to adjacent carts C stacked in the stack STK, may be connected in this manner in sequence, such as up to 8, 12 or more carts C, according to design. If desired, instead of having electrical cables 27 for coupling between successive power packs PP-1, use may be made of a rigid plug and socket arrangement whereby the mere stacking of carts C mutually couples the succession of power packs in electrical communication for simultaneous battery 11 recharge.

FIG. 2 shows a front view of an embodiment of the cart apparatus module I, which includes some of the elements thereof. The module I may include a power pack housing 28 which supports a holding device 30. The holding device 30 may include clamps 20, such as two movable clamps 20, for fixedly retaining an electronic apparatus 14 to the pack housing 28. An electronic apparatus 14, before or after being fixed to the holding device 30 by the clamps 20, may be electrically coupled by a suitable apparatus connector 16 selected out of the bundle of apparatus cables 13, to its dedicated recharging port for recharging the apparatus battery 11. Such recharging of an electronic apparatus 14 may typically occur during use of the cart C when the cart apparatus module I is disconnected from the stack charger 25, thus when the cart C is no longer coupled in a stack STK such as shown in FIG. 1. Consequently, the electronic apparatus 14 may be charged and powered, and the additional electronic device(s) 15 may be powered by the apparatus rechargeable battery 11 of the power pack PP-I. Electronic apparatus 14 may be clamped by the clamps 20 in horizontal or vertical orientation even though a horizontally held apparatus is shown in FIG. 2.

In an exemplary embodiment, there is provided a cart monitoring system CMS and method for monitoring an inventory of a list of mobile carts C for the purpose of preventing or mitigating the loss of carts C to avoid depletion of the inventory. Monitoring is considered to mean keeping count, tracking, locating, and monitoring the completeness of the inventory list of carts. The carts C may be equipped with valuable cart apparatus module I, such as for charging and supporting electronic apparatus 14 and additional electronic apparatus 15, as shown in FIGS. 1 and 2.

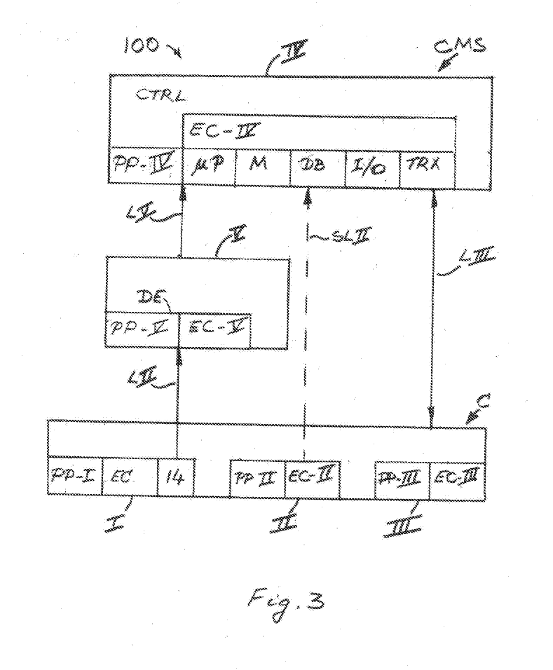

FIG. 3 is a block-diagram of an exemplary embodiment 100 of the cart monitoring system CMC showing five different modules, marked from I to V, which are configured to monitor an inventory list of carts C which may be disposed in the interior and on the exterior of a boundary B. For the sake of clarity there is shown but one cart C out of the plurality of carts, and one data exchanger DE out of the plurality of data exchangers.

The cart C may support the three modules I, II, and III or only one or two thereof. The cart support module I, was described hereinabove and is shown to include a power pack PP-I which is coupled to the optional support electronic interface 18, or electronic circuit EC-I. In turn, the electronic circuit EC-I may be coupled to the electronic device 14 for recharging and power provision purposes. Alternatively, the power pack PP-I may be coupled directly to the electronic device 14, and may be coupled to the cart data module II and to the GPS tracker module III.

The cart data module II may be coupled in electrical communication with the cart support module I, and may include a power pack PP-II having a rechargeable battery 11 which is coupled for the supply of power to the electronic circuit EC-II of the cart data module II. The power pack PP-II is optional since power for the electronic circuit EC-II may be received from the power pack PP-I of module I. The electronic circuit EC-II may include at least one electronic component operative to deliver at least the cart identity number CIDN to the control station IV via the data collection module V. This means that the electronic circuit EC-II may include for example a passive RFID tag or chip from which a cart identity number CIDN may be read, or an active emitter from which the cart identity number CIDN may be emitted, when the cart C arrives in appropriate data collection range of a compatible data exchanger DE pertaining to the data collection module V. RFID means Radio Frequency Identification. Alternatively, use may be made of an active RFID electronic element emitting data, for example, using a Bluetooth communication system. The cart data module II supported on a cart C may carry more than one RFID tag or chip, of more than one type. Evidently, the RFID tags and associated data exchanger DE are selected according to needs, requested performances, and costs.

Details about RFID may be found on the Internet, for example at “Radio-frequency identification Wikipedia”. In general, RFID tags are coupled for reading with appropriately selected types of tag readers, here data exchangers DE. RFID tags and RFID readers may be selected as desired. Preferably, the RFID tags are selected as read-only tags but other types of tags may also be used. Such read-only tags may be associated with RFID readers called Active Reader Passive Tag (ARPT) readers. In the present application, the readers, or data exchangers DE are stationary and the RFID tags which are supported by the carts C are mobile. Such fixed readers create a specific interrogation zone which can be tightly controlled. There is thereby create a highly defined reading area, and a controlled distance range allowing to detect the cart identity numbers CIDN of which cart(s) enter into or exit out of the interrogation zone, or range from a data exchangers DE. Such data may be collected in the memory by the module IV which is coupled to the data exchangers DE. A logic computer program executed by the processor of the module IV may take advantage of the known location of the data exchangers DE or RFID readers, as stored in memory, and may monitor the location of the various RFID tags supported in a cart data module II, i.e. in a cart C.

In addition, the electronic circuit EC-II may include a battery charge level reader BCHL, not shown in the Figs., able to derive the charge level of either one or both of the power packs PP-I and PP-II. The derived charge level BCHL may be transmitted to the control station IV either by an appropriate transmitter disposed on the electronic circuit EC-II which may receive the charge level of the power pack PP-I for transmission as shown via the dedicated second link SLII shown as a dashed arrow in FIG. 3. Alternatively, the battery charge level BCHL may be forwarded to a transmitter disposed on the GPS electronic circuit EC-III for transmission to the control station IV via the bidirectional link LIII shown as a double headed arrow in FIG. 3, or else, by other means. Like the cart identity number CIDN, the battery charge level BCHL is considered as being cart data, here additional cart data, which may be derived from the cart data module II or from the GPS tracker module III, and transmitted to the control station IV via the dedicated second communication link SLII.

The GPS tracker module III may be coupled in electrical communication with the modules II and I, and may include a power pack PP-III having a rechargeable battery 11 which is coupled for the supply of power to the GPS electronic circuit EC-III. GPS refers to Global Positioning System. The power pack PP-III is optional since power for the GPS electronic circuit EC-III may be received from the power pack PP-I of the module I, or from the power pack PP-II. The GPS tracker may be disposed on the GPS electronic circuit EC-III for tracking the location of a cart C which say, exited out of the boundary B of the monitoring system CMS. It is noted that a cart C exiting to the exterior EX of the boundary B, or out of a last allowed zone Z of the facility F, may not be returned to the cart inventory and may thus be lost. Such an event will cause the control station module IV to derive and associate a cart status condition CSC of ‘potential loss’ to the cart data. Such a cart status condition CSC may be regarded by the control station module IV as a selected status for which the cart data module may trigger the emission of an event notice, or a signal such as an alert signal will be delivered. This is particularly true when a cart C reaches the outdoors and exits out of the boundary B and receives a cart status condition CSC of ‘lost’. The position coordinates of the actual location of the GPS tracker module III supported by the cart C may allow a machine or personnel to reach the actual location of the cart C and recover that cart, or at least to be of assistance for the return and recovery of the cart. The GPS tracker module III may for example be triggered into operation by a command delivered by the control station IV in response to the derivation of a cart status condition such as ‘heading to potential loss’, or ‘potential loss’.

Hence, the GPS tracker module III may be coupled to the control station module IV by a bidirectional communication link LIII, in one direction to receive therefrom a trigger command for entering in operation and in a second direction, to deliver location data coordinates to the control station module IV. If desired, additional cart data, such as battery BCHL for example, may be transmitted to the control module IV via the bidirectional communication link LIII coupling the GPS tracked module III with the control station module IV.

Each one of the first three modules I-III, which may possibly be disposed in the housing 28, may have an independent rechargeable battery 11 or may be coupled to a same rechargeable battery. The independent batteries 11 may be charged for example from the electric-mains providing e.g. a 230V alternating current to an AC/DC rectifying transformer that may have an output of e.g. 5V DC. Preferably, the independent batteries 11 are charged in parallel, and when a cart C is disconnected from the mains and in operation, a diode disposed upstream of each independent battery 11 prevents one battery from drawing current from another battery.

The data collection system V includes a plurality of data exchangers DE which may be coupled in data communication with the cart support module I with the control station IV. Each data exchangers DE may be powered from the mains, thus from the main electric power supply, and may support a power pack PP-V such as a rechargeable battery, and may be coupled for the supply of power to a data collection circuit EC-V. The data exchangers DE may be distributed at predetermined locations at least in the facility F and if desired, in the area A and even in the exterior thereof, and may be configured to derive cart data from a cart data module II which comes in the vicinity or in communication range of a data exchanger DE. The data exchangers DE may be coupled by wired or wireless communication with the control station IV which collects and stores cart data, including the cart identity numbers CIDN and additional cart data attributes. The additional cart data attributes may include time data, battery charge level BCHL, the location of the cart data exchange DE which last communicated with the cart C, which location is considered as the location of a cart C. Communication from a data exchanger DE to the control module IV may be transmitted via the collection communication data link LII.

The control station IV including a controller CTRL, may be coupled to the electrical mains and may have a power pack PP-V having a rechargeable battery 11 which is coupled for the supply of power to a control electronic circuit EC-IV. The electronic circuit EC-IV may include a data processor operating a microprocessor μP which may be coupled to a memory M storing non-transitory computer programs SFTW and data, which are readable by the microprocessor μP and are dedicated to the command and control of the cart monitoring system CMS. The control electronic circuit EC-IV may be coupled to Input/Output (I/O) means, and may support a transmitter TRX, possibly a smart phone, a tablet, a laptop, and the like, for emitting and for receiving data and/or signals. The control electronic circuit EC-IV may further support a database DB for control of the inventory list of carts C. The microprocessor μP may use the memory M or the database DB to associate and correlate each cart C included in the inventory list of carts with: the cart identity numbers CIDN, time data, a location of the data exchangers DE which last sampled the cart C, and derive a cart status condition CSC which is associated with the cart C. The memory M may thus store a map DEM of the position location of each one of the distributed data exchangers DE in superposition of a map of the area A and the boundary B, including the zones Z of and the facility F and the exterior surroundings EX.

The controller CTRL may command the data sampling rate of the one or more data exchangers DE that sample and detect the physical presence of a cart C. A cart C that is headed for an immediate exit out of the boundary B, or may have exited into a prohibited region of travel, may be detected by the controller CTRL and may be tagged with a cart status condition CSC of ‘potential loss’. Such a cart status condition may be recognized as a selected cart status condition CSC and be recognized as cart event in response to which the controller CTRL issues at least a notice or an event report, or some a type of warning message. For example, a warning message such as at least one of: flashing light(s), a loudspeaker announcement, the disposition of a physical obstacle to the exit of a cart C, and the transmission of a local message or a message to a remote location. The control station module IV may thus detect and report if a cart C is missing from the inventory list.

The control station IV may also detect a congestion of carts C. In a retail shop it is important to avoid a congestion of carts at a same counter for the benefit of the customers. When a plurality of carts C arrive and remain in data communication range with a data exchangers DE for period exceeding a predetermined length of time, the controller CTRL may detect and derive a cart status condition CSC of ‘congestion’. A ‘congestion’ cart status condition may be recognized as a selected condition, and deliver an event notice. This means that the control station IV is configured to deliver notice when a plurality of cart identity numbers CIDN which exceeds a predefined congestion threshold level is received from a same data exchangers DE for a period of time which exceeds a predetermined length of time threshold. The congestion threshold level and the time threshold length may be stored in the database DB, and/or in the memory M, and/or be stored as a cart status condition CSC associated with cart identity numbers CIDN and time data.

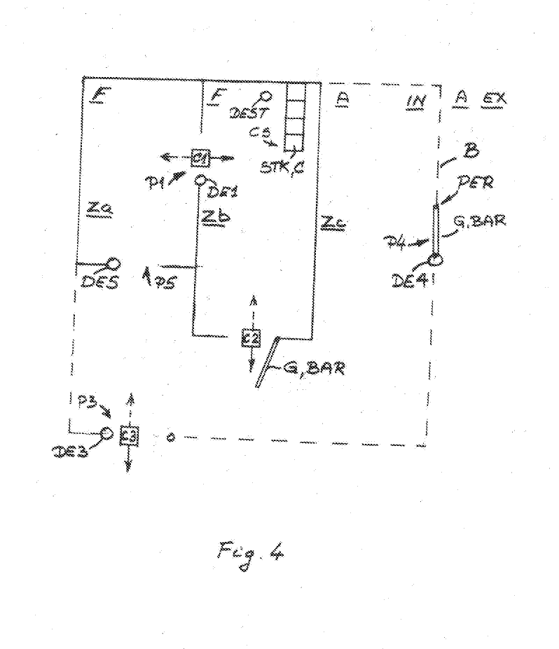

FIG. 4 illustrates an exemplary configuration of an environment wherewith the monitoring method and the monitoring system CMS may be implemented and operated. FIG. 4 shows a closed boundary B disposed in an area A, with the boundary having a boundary interior IN and a boundary exterior EX. The boundary B may include a facility F having an open air exterior surface zone. The facility F, which may be a building or a roofed surface, is divided for example into two zones Z, namely Za, and Zb. A zone Zc may be an open air surface, such as a parking lot for example. The zones Za and Zb. may have open passages, respectively P1 and P2 for free bidirectional travel therethrough of carts C. A cart C1 and a cart C2 may be disposed in the passages, respectively P1 and P2. Furthermore, data exchangers DE, here DE1 and DE2, are disposed at the passages, respectively P1 and P2. A stack STK of carts C is parked in the zone Zb next to a data exchanger DEST. Such a stack STK may hold carts C ready for use or be a stack of carts being electrically charged from a main electrical supply and having a cart status condition CSC of, respectively, ‘operative’, ‘stacked’ and ‘charging’. More carts C and more data exchangers DE may be distributed in the interior or the exterior of the boundary B but are not shown in FIG. 4 for the sake of clarity. The control station IV, which is not shown in FIG. 4, may be disposed in the interior or the exterior of the boundary B, and may possibly be disposed remote from the boundary. A cart C which communicates with a data exchanger DE disposed on the exterior of the boundary B does certainly deserve a cart status condition of ‘lost’. The control station module IV responds to such an event by the delivery of an event notice in response to which cart C recovery steps have to be taken.

In FIG. 4, a cart C3 is shown to be disposed in the passage P3, next to a data exchanger DE3. The passage P3, which leads to the exterior of the boundary B, may have a physical obstacle, such as a barrier BAR or a gate G which may have an obstacle open state and an obstacle closed state but is shown in the open state. A second obstacle is shown in the closed state at a passage P4, next to which a data exchanger DE4 is disposed.

When the cart C1 is driven from the direction from zone Za into the zone Zb, or into the opposite direction via the passage P1, the data exchanger DE1 may derive at least the cart identity number CIDN of the cart and may keep the cart status condition CDC as ‘in use’. In addition, the data exchanger DE1 may update the zone into which the cart C1 becomes operative. The data exchanger DE1 may derive further data, such as a threshold level of charge LOC or battery charge level of one or more batteries 11, and keep the cart status condition CDC as ‘charged’, or update the cart status condition for example to ‘low charge’, or to ‘recharge’. Data derived from the cart C1 may be communicated as cart data to the control station IV for processing, recognition as a selected condition, and delivery of an event notice requesting action to remediate the situation.

With the cart C2, the data exchanger DE2 may apply the same data derivation as for the cart C1, but this time it is necessary to distinguish whether the direction of the cart C2 is into or out of the zone Zb. Exit of the cart C2 via the passage P2 out of the zone Zb requires the cart status condition CDC to be updated to ‘watch’ since the cart may exit out of the boundary B and be lost. For detection of direction of travel, an appropriate electronic component may be used, or two components, one with a short range vicinity detection capability of the cart C2, and a second component with a longer range of detection capability: these two components suffice to indicate the direction of travel. Else, two data exchangers DE may be operated, and again, the sequence of detection will indicate the direction of travel of the cart C2. The return of cart C2 back into the zone Zb may apply the same data derivation procedure as described for the cart C1. However, exit of the cart C2 into the open air portion EX of the area A will update the cart status condition CDC to ‘watch’, which if desired, may cause the controller CTRL to respond by triggering the GPS tracker III into operation. The GPS tracker III may emit the location coordinates of the cart data module II, thus of the cart C2.

Exit of the cart C3 via the open gate G of the passage P3 which is disposed in the open state, and out of the boundary B, will be detected by the data exchanger DE3. The exit of cart C3 will be communicated from the data exchanger DE3 to the controller CTRL, and be followed by the cart status condition CSC to be set to ‘loss’. Simultaneously, the controller CTRL will command to operate the GPS tracker III. The GPS tracker III may emit the location coordinates of the cart data module II, thus of the cart C3. Cart recovery action may be started to recover and return the cart C3 back into the boundary B. Alternatively, detection of the direction of travel of the cart C3 may cause the controller CTRL to command the closure of the gate G to present a physical obstacle and prevent passage of the cart C3 to the exterior of the boundary B. A gate G in the closed state is shown at the passage P4. Concurrently, the control station IV may update the cart status condition CSC, detect a selected condition, recognize a cart event and deliver an event notice including visual and audible alarm signals, and may transmit a message to remote parties. However, if so desired, the cart C3 may be tagged with a cart status condition CSC of ‘exit permission’ and be allowed to exit out of the boundary B. Evidently, other cart C passage detection configurations are possible.

In addition to the exemplary embodiment 100 for the implementation of a cart monitoring system CMS which was described hereinabove, further embodiment may also be considered.

In the exemplary embodiment 100, although not shown in the Figs., the first three modules I-III may have a common power pack PP-COM3, and/or a common electronic circuit EC-COM3.

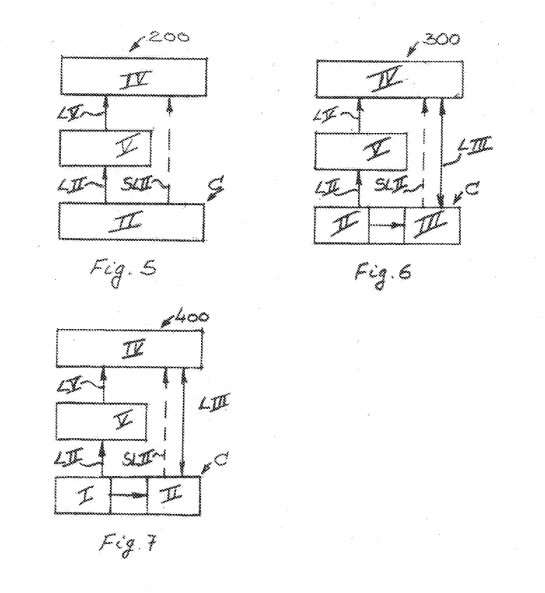

FIG. 5 illustrates an exemplary embodiment 200 which may include the modules II, IV, and V, thus be different from the exemplary embodiment 100 by omitting the GPS tracker module III. In this case, the operation of the cart monitoring system CMS will be similar to the operation of the embodiment 100, but without the ability to track and locate the position coordinates of a cart C that has exited out of the boundary B. In the exemplary embodiment 200, the cart data module II is coupled in communication with the data collection module V via a collection communication link LII, and the data collection module V is coupled in communication with the control station module IV via a control communication link LV. Furthermore, cart data, such as additional cart data, i.e. battery charge level BCHL for example, may be transmitted from the cart data module II via a dedicated second communication link SLII, to the control station module IV.

FIG. 6 depicts another exemplary embodiment 300 which may include the modules II, III, IV, and V, thus without the cart apparatus module I. The operation of the cart monitoring system CMS will be similar to the operation of the embodiment 100, but will miss the ability to track and locate the position coordinates of a cart C that has exited out of the boundary B. Data derived by the module II such as battery charge level BCHL for example, may be transmitted to the control station IV either by an appropriate transmitter disposed on the electronic circuit EC-II which may derive the charge level of the power pack PP-I for transmission via the dedicated second link SLII shown as a dashed arrow in FIG. 6. Alternatively, the battery charge level BCHL may be forwarded to a transmitter disposed on the GPS electronic circuit EC-III for transmission to the control station IV via the bidirectional communication link LIII shown as a double headed arrow in FIG. 3, or else, by other means. With the exemplary embodiment 300, the data links LII, LV, and SLII are the same as those described with respect to the exemplary embodiment 200. Moreover, but not shown in the Figs., the exemplary embodiment 300 may have either two electronic circuits, i.e. EC-II and EC-III, or one common electronic circuit EC-COM2. If desired, but not shown in the Figs., the exemplary embodiment 300 may have either two power packs, namely PP-II and PP-III, or one common power pack PP-COM2, to supply power to the modules I and II. The electronic circuits EC for the modules I, and II may be combined into a common electric circuit EC-COM2, not shown in the Figs.

FIG. 7 shows yet another exemplary embodiment 400 which may include the modules I, II, IV, and V, hence without the GPS tracker module III. The operation of the cart monitoring system CMS will be similar to the operation of the embodiment 100, but will miss the ability to track and locate the position coordinates of a cart C that has exited out of the boundary B. Data derived by the module II such as battery charge level BCHL for example, may be transmitted to the control station IV by an appropriate transmitter disposed on the electronic circuit EC-II which may derive the battery charge level of the power pack PP-I for transmission via the dedicated second link SLII shown as a dashed arrow in FIG. 7. If desired, but not shown in the Figs., the exemplary embodiment 400 may have either three power packs, namely PP-I, PP-II and PP-III, or two power packs PP-COM2 or one common power pack PP-COM3 to supply power to the modules I, II, and III. The electronic circuits EC for the modules I, II, and III may be combined in the same manner as the power packs PP, into two electronic circuits.

The cart monitoring system CMS may be built and implemented y means and techniques well known to those skilled in the art and needs therefore not to be described in further details.

Assuming that the carts C supporting at least the cart data module II module are available, the operation of the cart monitoring system CMS is quite obvious. After the location of the data exchangers DE has been mapped and stored in memory M, and after the control station module IV has been assembled and properly connected to the data collection module V, running the cart monitoring system CMS is left to the operator, which is shown in the Figs. The operator will be able to track and monitor the carts C by use of an input/output device I/O of the control station module IV. Since the cart monitoring system CMS operates under command of the controller CTRL, the task of the operator will mainly involve the supervision of the execution of operations to be performed in response to cart event notices. For example, such a task may include the recovery of a cart having a cart status condition of ‘lost’, which means that the cart has been driven to the exterior of the boundary B.

There has thus been described a cart monitoring system CMS for monitoring each cart C out of an inventory list of a plurality of carts, and a method for mitigating a loss of a cart out of an inventory list of a plurality of carts. The cart monitoring system CMS includes carts C that supports a cart data module II which is configured to hold cart data. For each cart C, cart data includes at least a cart identity number CIDN and may include additional cart data such as battery charge level(s) BCHL. The cart monitoring system CMS further includes a data collection module V having a plurality of data exchangers DE wherein each data exchanger out of the plurality of data exchangers is disposed at a known location and is configured to derive cart data when a cart enters in communication range therewith. A data exchanger DE is a device which is configured to communicate with cart data module II for the exchange of data, thus for the collection of information stored in the cart data module II. For example, a data exchanger DE may read an RFID chip which is supported by the cart data module II. The location where each data exchanger DE is disposed is known to the system, either as a list or as a map stored in the system. In addition, the cart monitoring system CMS may operate a control station IV which is coupled in communication with each data exchanger DE, wherein the control station is configured to collect, store and associate: cart data from each data exchanger, the location of the data exchanger DE, and the time of the data exchange, or time data. The location of each data exchanger DE is either collected from the data exchanger or from data that is stored in the control station IV as a list or as a map of data exchangers. For each cart, the control station IV processes and correlates time data, and stored data to derive a cart status condition, detect selected cart data condition(s), and if detected, recognize the occurrence of a cart related events, and deliver a report notice in response to the events. Selected cart data conditions are conditions for which an immediate response is required, such as the imminent loss of a cart C.A selected cart data condition is checked, and if valid, is recognized as a cart event in response to which a report notice is delivered.

The control station V is evidently configured to chronologically update and store the inventory list of carts C.

Cart data from the cart data module II may be transmitted to the data collection module V via a collection communication link LII. Additional cart data may be transmitted to the control station IV via a dedicated second communication link SLII, and the data collection module is coupled in communication with the control station module via a control communication link LV.

The control station includes a controller CTRL which may be configured to derive and update an at least one cart status condition for each cart.

The controller CTRL may be configured to deliver a notice for selected cart status condition(s).

Each cart C may support a cart apparatus module I which is configured to power and charge at least one electronic device which is coupled thereto, and may further be coupled to the cart data module II which is also supported on the cart.

A cart C may support a GPS tracker module III which is configured to derive the location position coordinates of a cart C. The GPS tracker module III is coupled to the cart data module II which is supported on the cart C.

The GPS tracker module III and the control station IV are coupled by a bidirectional communication link LIII, and the GPS tracker module may be triggered into operation by the control station IV which in response thereto, transmits cart location coordinates to the control station.

The operation of the cart monitoring system CMS may extend to cover an area A and a boundary B which includes at least one of: an interior IN of the boundary and an exterior EX of the boundary, at least one zone Z in the interior of the boundary, a roof covered zone Z in the interior of the boundary, an open air zone, and at least one facility F in the boundary.

The boundary B is configured to delimit a closed periphery PER which may include at least one physical obstacle G, BAR, which may have an open obstacle state and a closed obstacle stat. The controller CTRL may be configured to command the opening of the physical obstacle to the open obstacle state and to the closed obstacle state.

There is described a method for mitigating a loss of a cart C out of an inventory list of a plurality of carts wherein the method may use the cart monitoring system CMS. The method may comprise the provision of each cart C with cart data CD which may include at least a cart identity number CIDN. The cart data CD may be stored in a cart data module II. There is also provided a map DEM designating the location of each data exchanger DE out of a plurality of data exchangers included in a data collection module V. Further, the method derives cart data CD from each data exchanger DE when entering in communication range with a cart C. Moreover, the method provides a communication link LV coupling between a control station module IV including a controller CTRL and each data exchanger DE. In addition, the method operates the controller CTRL for collecting cart data CD from each data exchanger DE, and stores the location of the data exchanger, the time. Finally, for each cart, the method processes and correlates the actual time, the cart data CD, and the stored location data of the data exchanger DE for deriving a cart status condition.

A cart status condition CSC may include at least one status which is designated as: operative, in use, defective, charged, low charge, charging, operative cart in parking, carts congestion, heading to potential loss, potential loss, and out of boundary.

The controller may include a memory M for storage of data and of preloaded non-transitory software computer programs SFTW which are readable by a processor, which processor may deliverer an event report notice in response to selected cart status condition(s). The selected cart status condition(s) CSC may include at least one status condition of: defective, carts congestion, heading to potential loss, potential loss, and out of boundary.

The controller CTRL may operate in association with a closed boundary B including a physical obstacle G, BAR, having an open obstacle state and a closed obstacle state, and the controller may command the physical obstacle to open in an open obstacle state and to close in a closed obstacle state. Such a command may be delivered by the controller CTRL in response to a chosen selected cart status condition.

With the method, a plurality of carts C may be stacked in a stack STK and may be coupled in mutual electrical communication to a main electrical supply. At least one cart out of the stack may support a rechargeable battery which is recharged from the main electrical supply. The at least one cart C may supports a cart apparatus module I which may be configured to power at least one electronic device 14.

With the method, the inventory list may be updated chronologically

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

List of Reference Signs

| | |
|---|---|
| I | cart apparatus module |
| II | cart data module |
| III | GPS tracker module |
| IV | control station module |
| V | data collection module |
| 11 | rechargeable battery |
| 12 | device support |
| 13 | apparatus cables |
| 14 | electronic device |
| 15 | additional electronic device |
| 16 | apparatus cables |
| 17 | handle |
| 18 | electronic circuit interface or EC-I |
| 20 | clamps |
| 21 | inlet interface |
| 23 | outlet interface |
| 25 | stack charger |
| 27 | electrical cable |
| 28 | power pack housing |
| 30 | holding device |
| A | area |
| B | boundary |
| BAR | barrier |
| BCHL | battery charge level |
| C | cart |
| CD | cart data |
| CIDN | cart identity number |
| CMS | cart monitoring system |
| CSC | cart status condition |
| CTRL | controller |
| DE | data exchanger |
| EC | electronic circuit |
| EX | exterior |
| F | facility |
| G | gate |
| IN | interior |
| I/O | input/output means |
| L | bidirectional link |
| LOC | level of charge |
| M | memory |
| MP | microprocessor |
| P | passage |
| PP | power pack |
| PER | periphery |
| STK | stack |
| SFTW | non-transitory program |
| Z | zone |

1. A cart monitoring system for monitoring each cart out of an inventory list of a plurality of carts, the monitoring system comprising:
a cart data module supported by the cart and configured to hold cart data,
a data collection module including a plurality of data exchangers, wherein each data exchanger out of the plurality of data exchangers is disposed at a known location and is configured to derive cart data when a cart enters in communication range therewith,
a control station coupled in communication with each data exchanger, wherein the control station is configured to collect cart data via each data exchanger, store data exchanger location, and for each cart:
process and correlate time data, cart data, and stored data to derive a cart status condition, detect cart related event(s), and deliver a report notice in response to the event(s).

2. The cart monitoring system of claim 1, wherein the control station is configured to chronologically update the inventory list.

3. The cart monitoring system of claim 1, wherein cart data includes at least a cart identity number.

4. The cart monitoring system of claim 1, wherein:
cart data from the cart data module is transmitted to the data collection module via a collection communication link,
additional cart data is transmitted to the control station via a dedicated second communication link, and
the data collection module is coupled in communication with the control station module via a control communication link.

5. The cart monitoring system of claim 1, wherein the control station includes a controller which is configured to derive and update an at least one cart status condition for each cart.

6. The cart monitoring system of claim 5, wherein the controller is configured to deliver a notice for selected cart status condition(s).

7. The cart monitoring system of claim 1, wherein a cart apparatus module configured to power and charge at least one electronic device which is coupled thereto, is coupled to the cart data module which is supported on the cart.

8. The cart monitoring system of claim 1, wherein a GPS tracker module configured to derive location position coordinates of a cart is coupled to the cart data module which is supported on the cart.

9. The cart monitoring system of claim 8, wherein
the GPS tracker module and the control station are coupled by a bidirectional communication link, and
the GPS tracker module is triggered into operation by the control station which in response, transmits cart location coordinates to the control station.

10. The cart monitoring system of claim 8, wherein:
a cart apparatus module is configured to power and charge at least one electronic device which is coupled thereto, and
the cart apparatus module is coupled to the cart data module which is supported on the cart.

11. The cart monitoring system of claim 1, wherein:
operation of the system extends to cover an area and a boundary, and includes at least one of:
an interior of the boundary and an exterior of the boundary, at least one zone in the interior of the boundary, a roof covered zone in the interior of the boundary, and an open air zone, and a facility in the interior of the boundary which includes at least one zone.

12. The cart monitoring system of claim 11, wherein:
the boundary is configured to delimit a closed periphery including at least one physical obstacle having an open obstacle state and a closed obstacle state, and
the controller is configured to command opening of the physical obstacle to one of the open obstacle state and the closed obstacle state.

13. A method for mitigating a loss of a cart out of an inventory list of a plurality of carts, the method comprising:
providing each cart with cart data including at least a cart identity number, wherein cart data is stored in a cart data module,
providing a map DEM designating a location for each data exchanger out of a plurality of data exchangers included in a data collection module, and deriving cart data from each data exchanger upon entering in communication range with a cart,
providing a communication link coupling between a control station including a controller and each data exchanger, operating the controller for collecting cart data from each data exchanger, storing data exchanger location, and for each cart:
processing and correlating time data, cart data, and stored data exchanger location data for deriving a cart status condition.

14. The method of claim 11, wherein a cart status condition includes at least one status condition of: operative, in use, defective, charged, low charge, recharge, charging, operative, cart in parking, stacked, congestion, watch, exit permission, heading to potential loss, potential loss, lost, and out of boundary.

15. The method of claim 12, wherein the controller includes:
a memory for storage of data and of preloaded non-transitory software computer programs which are readable by a processor, and
the processor being configured for delivering an event report notice in response to selected cart status condition(s).

16. The method of claim 13, wherein a selected cart status condition(s) includes at least one status condition of: defective, congestion, heading to potential loss, potential loss, loss, and out of boundary.

17. The method of claim 16, wherein:
the controller operates in association with a closed boundary including a physical obstacle having an open obstacle state and a closed obstacle state, and
the controller commands the physical obstacle into the open obstacle state and the closed obstacle state.

18. The method of claim 13, wherein:
a plurality of carts are disposed in stack and are coupled in mutual electrical communication to a main electrical supply, and
at least one cart out of the stack supports a rechargeable battery which is recharged from the main electrical supply.

19. The method of claim 18, wherein:
the at least one cart supports a cart apparatus module which is configured to power at least one electronic device.

20. The method of claim 13, wherein: the inventory list is updated chronologically.
